(19) United States
(12) Patent Application Publication
(10) Pub. No.: US 2019/0364452 A1
(43) Pub. Date: Nov. 28, 2019

(54) METHOD AND TERMINAL FOR PERFORMING MEASUREMENT IN NEXT GENERATION MOBILE COMMUNICATION SYSTEM

(71) Applicant: LG ELECTRONICS INC., Seoul (KR)

(72) Inventors: Jinyup HWANG, Seoul (KR); Yoonoh YANG, Seoul (KR); Sangwook LEE, Seoul (KR); Suhwan LIM, Seoul (KR); Manyoung JUNG, Seoul (KR)

(73) Assignee: LG ELECTRONICS INC., Seoul (KR)

(21) Appl. No.: 16/478,441

(22) PCT Filed: Nov. 8, 2017
(86) PCT No.: PCT/KR2017/012599

§ 371 Date: Jul. 16, 2019

Related U.S. Application Data
(60) Provisional application No. 62/457,115, filed on Feb. 9, 2017.

(51) Int. Cl. H04W 24/10; H04W 16/28; H04B 17/318; H04W 56/00

(52) U.S. Cl. CPC H04W 24/10; H04W 56/001; H04B 17/318; H04W 16/28

(57) ABSTRACT

One disclosure of present specification presents a measurement method. The measurement method can comprise the steps of: receiving information on a first measurement gap from a serving cell; and performing measurement on the basis of a synchronization signal (SS) burst received from one or more neighboring cells during the first measurement gap indicated by the information, wherein the SS burst can include a plurality of SS blocks. The first measurement gap can be set on the basis of the period of the SS burst for the serving cell and the period of the SS burst for the one or more neighboring cells. The reception of the signal from the serving cell can be stopped during the first measurement gap.

### BACKGROUND OF THE INVENTION

### Field of the invention

The present invention relates to a next generation mobile communication.

### Related Art

With the success of long term evolution (LTE)/LTE-A (LTE-Advanced) for the 4th generation mobile communication, more interest is rising to the next generation, i.e., 5th generation (also known as 5G) mobile communication and extensive research and development are being carried out accordingly.

The 5G mobile communication defined in the international telecommunication union (ITU) provides a data transfer rate of up to 20 Gbps and a sensible transfer rate of at least 100 Mbps anytime anywhere. ‘IMT-2020’ is a formal name, and aims to be commercialized in the year 2020 worldwide.

The ITU proposes three usage scenarios, e.g., eMBB (enhanced Mobile BroadBand), mMTC (massive Machine Type Communication), and URLLC (Ultra Reliable and Low Latency Communications).

First, the URLLC relates to a usage scenario which requires a high reliability and a low latency. For example, a service such as autonomous driving, factory automation, and augmented reality requires a high reliability and a low latency (e.g., a latency less than or equal to 1 ms). At present, a latency of 4G (LTE) is statistically 21-43 ms (best 10%), 33-75 ms (median). This is insufficient to support a service requiring the latency less than or equal to 1 ms. Therefore, in order to support the URLLC usage scenario, a packet error rate (PER) below 10-5 and a latency of 1 ms are required. Herein, the latency is defined as a latency between a MAC layer of a UE and a MAC layer of a network. At present, in the 3 GPP standard group, a standardization is carried out in two ways, i.e., a way of decreasing a latency and a way of increasing reliability in order to support URLCC. First, as the way of decreasing the latency, a transmission time interval (TTI) is defined to be less than or equal to 1 ms to redefine a radio frame structure, to adjust an HARQ scheme at an L2 layer, and to improve an initial attach procedure and scheduling. As the way of increasing the reliability, a multiple connectivity, a frequency/space-domain multi-link diversity, a higher-layer data duplication scheme, or the like are taken into account.

Next, an eMBB usage scenario relates to a usage scenario requiring a mobile ultra-wide band.

Beamforming, massive MIMO, full dimensional MIMO (FD-MIMO), array antenna, analog beamforming, and large scale antenna techniques are discussed in a 5G mobile communication system in order to achieve a high data transfer rate. In addition, there is ongoing discussion on a non-orthogonal multiple access (NOMA) technique to enable a service of a great number of terminals. While the existing OFDMA scheme is the concept in which resources are allocated orthogonally to users by dividing time and frequency with respect to each user, the NOMA intends to increase band efficiency by allowing multiple users to be able to use the same resource.

Meanwhile, a multi-user MIMO technique may lead to an increase in band efficiency. This is a scheme of supporting multiple users with the same resource by using a spatial feature of multiple antennas. The band efficiency can be increased by increasing the number of users that can be supported at the same time while increasing the number of antennas of a receiving end. In particular, the number of antennas that can be integrated physically can be increased as a frequency band becomes a high frequency band.

As such, in order to realize the ultra-wide band in a next-generation mobile communication system, it seems that the number of antennas will be more increased in the existing LTE system.

[symbol]

On the other hand, in the next-generation mobile communication system, beamforming may be applied to transmission of a synchronization signal and a reference signal. In this case, even if a terminal is capable of performing measurement without RF retuning for the neighbor cells on intra-frequency, beam sweeping for a beamforming direction is necessary. For example, when the terminal performs beam sweeping according to the beam of the neighbor cell, the terminal cannot receive a reference signal (RS) or data from a serving base station.

### SUMMARY OF THE INVENTION

Accordingly, a disclosure of the present specification aims to solve the aforementioned problem. That is, the disclosure of the present specification aims to provide a scheme of allowing a terminal to be able to perform measurement in a next-generation mobile communication system.

To achieve the above purpose, a disclosure of the present specification proposes a measurement method. The measurement method may include: receiving information on a first measurement gap from a serving cell; and performing measurement based on a synchronization signal (SS) burst received from one or more neighbor cells during the first measurement gap indicated by the information. In this case, the SS burst may include a plurality of SS blocks. The first measurement gap may be configured based on a periodicity of the SS burst for the serving cell and a periodicity of the SS burst for the one or more neighbor cells. Reception of the signal from the serving cell may be stopped during the first measurement gap.

During the first measurement gap, beam sweeping may be performed to receive the SS burst from the neighbor cell.

The serving cell and the neighbor cell may have an intra-frequency relation.

The SS block may include one or more of a primary synchronization signal, a secondary synchronization signal, and a physical broadcast channel (PBCH).

The method may further include: receiving information on a second measurement gap from the serving cell; and performing reference signal received power (RSRP) measurement based on a reference signal (RS) from the one or more neighbor cells during the second measurement gap.

The first measurement gap and the second measurement gap may do not overlap with each other.

If a periodicity of an SS burst for the serving cell and a periodicity of an SS burst for the one or more neighbor cells are fully matched to each other, the first measurement gap may be configured based on the periodicity of the SS burst for the serving cell.

If there is any neighbor cell of which a periodicity of an SS burst is matched to a periodicity of an SS burst for the serving cell, the first measurement gap may be configured based on a multiple for the periodicity of the SS burst for the serving cell.

If a least common multiple (LCM) of SS burst periodicities of the neighbor cells is less than the SS burst periodicity of the serving cell, the first measurement gap may be configured based on the periodicity of the SS burst for the serving cell.

The first measurement gap may be configured by further considering an offset.

To achieve the above purpose, a disclosure of the present specification proposes a terminal. The terminal may include: a transceiver for receiving information on a first measurement gap from a serving cell; and a processor for performing measurement based on a synchronization signal (SS) burst received from one or more neighbor cells during the first measurement gap indicated by the information. The SS burst may include a plurality of SS blocks. The first measurement gap may be configured based on a periodicity of the SS burst for the serving cell and a periodicity of the SS burst for the one or more neighbor cells. Reception of the signal from the serving cell may be stopped during the first measurement gap.

According to the disclosure of the present invention, the problem of the conventional technology described above may be solved.

### BRIEF DESCRIPTION OF THE DRAWINGS

FIG. 1 is a wireless communication system.

FIG. 2 illustrates a structure of a radio frame according to FDD in 3GPP LTE.

FIG. 3 shows a measurement and measurement reporting procedure.

FIG. 4 shows an example of a subframe type in NR.

FIG. 5 shows an example of beam sweeping of a synchronization signal (SS) in NR.

FIG. 6 shows a frequency position and periodicity of an SS burst.

FIG. 7 shows an example in which a serving cell and neighbor cells have a unified SS burst periodicity.

FIG. 8 shows an example in which SS burst periodicities of a serving cell and neighbor cells are set differently.

FIG. 9 shows a case where there is an SS burst periodicity of a serving cell out of SS burst periodicities of neighbor cells.

FIG. 10 shows a case where a least common multiple (LCM) of SS burst periodicities of neighbor cells is less than an SS burst periodicity of a serving cell.

FIG. 11 shows a case where a least common multiple (LCM) of SS burst periodicities of neighbor cells is greater than an SS burst periodicity of a serving cell.

FIG. 12 shows an example of an intra RSRP measurement gap to be proposed.

FIG. 13 is a flowchart briefly summarizing and showing a disclosure of the present specification.

FIG. 14 is a block diagram showing a wireless communication system for implementing a disclosure of the present specification.

### DESCRIPTION OF EXEMPLARY EMBODIMENTS

The technical terms used herein are used to merely describe specific embodiments and should not be construed as limiting the present invention. Further, the technical terms used herein should be, unless defined otherwise, interpreted as having meanings generally understood by those skilled in the art but not too broadly or too narrowly. Further, the technical terms used herein, which are determined not to exactly represent the spirit of the invention, should be replaced by or understood by such technical terms as being able to be exactly understood by those skilled in the art. Further, the general terms used herein should be interpreted in the context as defined in the dictionary, but not in an excessively narrowed manner.

The expression of the singular number in the present invention includes the meaning of the plural number unless the meaning of the singular number is definitely different from that of the plural number in the context. In the following description, the term ‘include’ or ‘have’ may represent the existence of a feature, a number, a step, an operation, a component, a part or the combination thereof described in the present invention, and may not exclude the existence or addition of another feature, another number, another step, another operation, another component, another part or the combination thereof.

The terms ‘first’ and ‘second’ are used for the purpose of explanation about various components, and the components are not limited to the terms ‘first’ and ‘second’. The terms ‘first’ and ‘second’ are only used to distinguish one component from another component. For example, a first component may be named as a second component without deviating from the scope of the present invention.

It will be understood that when an element or layer is referred to as being “connected to” or “coupled to” another element or layer, it can be directly connected or coupled to the other element or layer or intervening elements or layers may be present. In contrast, when an element is referred to as being “directly connected to” or “directly coupled to” another element or layer, there are no intervening elements or layers present.

Hereinafter, exemplary embodiments of the present invention will be described in greater detail with reference to the accompanying drawings. In describing the present invention, for ease of understanding, the same reference numerals are used to denote the same components throughout the drawings, and repetitive description on the same components will be omitted. Detailed description on well-known arts which are determined to make the gist of the invention unclear will be omitted. The accompanying drawings are provided to merely make the spirit of the invention readily understood, but not should be intended to be limiting of the invention. It should be understood that the spirit of the invention may be expanded to its modifications, replacements or equivalents in addition to what is shown in the drawings.

As used herein, ‘base station’ generally refers to a fixed station that communicates with a wireless device and may be denoted by other terms such as eNB (evolved-NodeB), BTS (base transceiver system), or access point.

As used herein, ‘user equipment (UE)’ may be stationary or mobile, and may be denoted by other terms such as device, wireless device, terminal, MS (mobile station), UT (user terminal), SS (subscriber station), MT (mobile terminal) and etc.

[symbol]

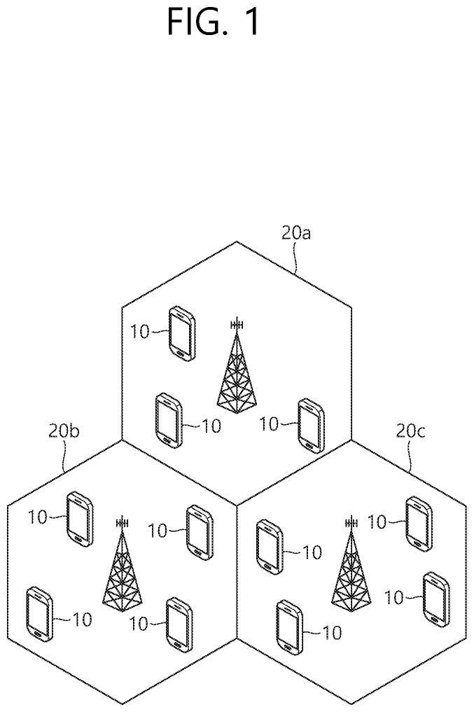

FIG. 1 illustrates a wireless communication system.

As seen with reference to FIG. 1, the wireless communication system includes at least one base station (BS) 20. Each base station 20 provides a communication service to specific geographical areas (generally, referred to as cells) 20a, 20b, and 20c. The cell can be further divided into a plurality of areas (sectors).

The UE generally belongs to one cell and the cell to which the UE belong is referred to as a serving cell. A base station that provides the communication service to the serving cell is referred to as a serving BS. Since the wireless communication system is a cellular system, another cell that neighbors to the serving cell is present. Another cell which neighbors to the serving cell is referred to a neighbor cell. A base station that provides the communication service to the neighbor cell is referred to as a neighbor BS. The serving cell and the neighbor cell are relatively decided based on the UE.

Hereinafter, a downlink means communication from the base station 20 to the UE 10 and an uplink means communication from the UE 10 to the base station 20. In the downlink, a transmitter may be a part of the base station 20 and a receiver may be a part of the UE 10. In the uplink, the transmitter may be a part of the UE 10 and the receiver may be a part of the base station 20.

Hereinafter, the LTE system will be described in detail.

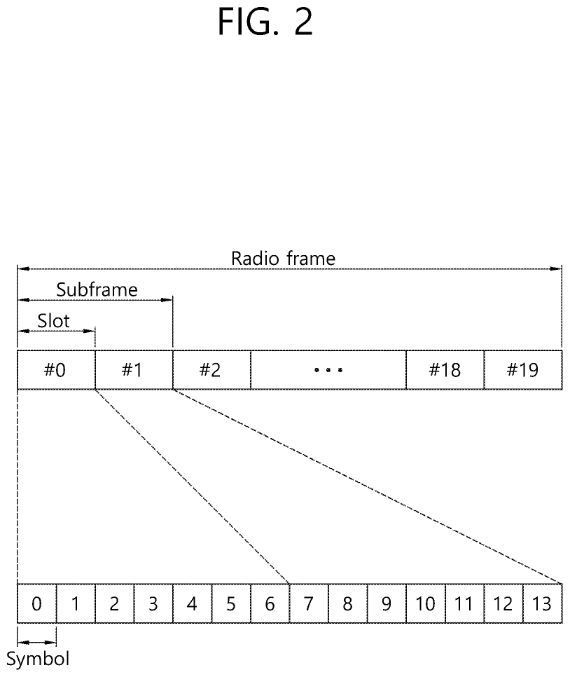

FIG. 2 shows a downlink radio frame structure according to FDD of 3rd generation partnership project (3GPP) long term evolution (LTE).

The radio frame of FIG. 2 may be found in the section 5 of 3GPP TS 36.211 V10.4.0 (2011-12) “Evolved Universal Terrestrial Radio Access (E-UTRA); Physical Channels and Modulation (Release 10)”.

The radio frame includes 10 sub-frames indexed 0 to 9. One sub-frame includes two consecutive slots. Accordingly, the radio frame includes 20 slots. The time taken for one sub-frame to be transmitted is denoted TTI (transmission time interval). For example, the length of one sub-frame may be 1 ms, and the length of one slot may be 0.5 ms.

The structure of the radio frame is for exemplary purposes only, and thus the number of sub-frames included in the radio frame or the number of slots included in the sub-frame may change variously.

One slot includes NRB resource blocks (RBs) in the frequency domain. For example, in the LTE system, the number of resource blocks (RBs), i.e., N_{RB}, may be one from 6 to 110.

The resource block is a unit of resource allocation and includes a plurality of sub-carriers in the frequency domain. For example, if one slot includes seven OFDM symbols in the time domain and the resource block includes 12 sub-carriers in the frequency domain, one resource block may include 7×12 resource elements (REs).

[symbol]

### Measurement and Measurement Reporting

It is necessary for a mobile communication system to support a mobility of a user equipment (UE) 100. Therefore, the UE 100 persistently measures quality of a serving cell currently providing a service and quality of a neighbor cell. The UE 100 reports a measurement result to a network at a proper time, and the network provides an optimal mobility to the UE through a handover or the like. Measurement of this purpose is ordinarily called radio resource management (RRM).

Meanwhile, the UE 100 monitors downlink quality of a primary cell based on a CRS. This is called radio link monitoring (RLM).

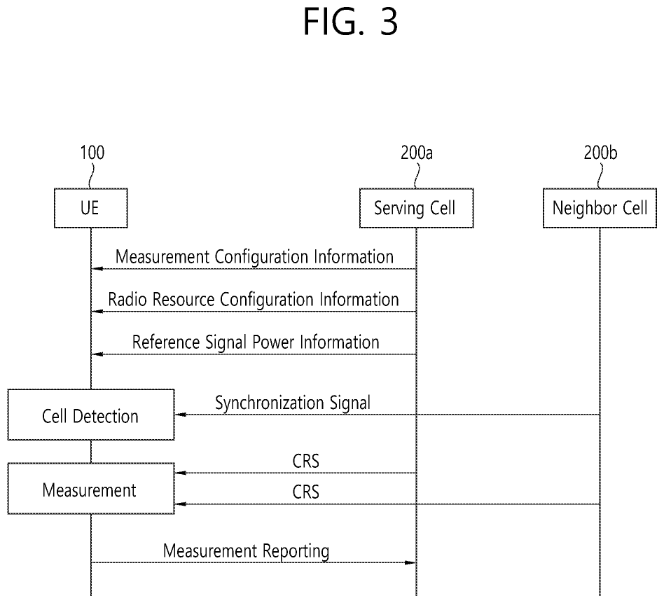

FIG. 3 shows a measurement and measurement reporting procedure.

As can be seen with reference to FIG. 3, a UE detects a neighbor cell based on a synchronization signal (SS) transmitted from the neighbor cell. The SS may include a primary synchronization signal (PSS) and a secondary synchronization signal (SSS).

In addition, when each of a serving cell 200a and a neighbor cell 200b transmits a cell-specific reference signal (CRS) to the UE 100, the UE 100 performs measurement through the CRS and transmits a measurement result to the serving cell 200a. In this case, the UE 100 compares power of the received CRS, based on information on received reference signal power.

In this case, the UE 100 may perform measurement by using the following three methods.

1) Reference signal received power (RSRP): It indicates average received power of all REs for carrying a CRS transmitted across a whole band. In this case, average received power of all REs for carrying a channel state information (CSI)-reference signal (RS), instead of the CRS, may be measured.

2) Received signal strength indicator (RSSI): It indicates received power measured at a whole band. The RSSI includes all of a signal, an interference, and a thermal noise.

3) Reference symbol received quality (RSRQ): It indicates a CQI, and may be determined as a ‘RSRP/RSSI’ based on a measurement bandwidth or subband. That is, the RSRQ implies a signal-to-noise interference ratio (SINR). Since the RSRP cannot provide sufficient mobility information, RSRQ may be used instead of the RSRP in a handover or cell reselection procedure.

It may be calculated that RSRQ=RSSI/RSSP.

Meanwhile, the UE 100 receives a measurement configuration information element (IE) from the serving cell 100a for the measurement. A message including the measurement configuration IE is called a measurement configuration message. Herein, the measurement configuration IE may also be received through an RRC connection reconfiguration message. If a measurement result satisfies a reporting condition in the measurement configuration information, the UE reports the measurement result to a base station. A message including the measurement result is called a measurement reporting message.

The measurement configuration IE may include measurement object information. The measurement object information is information on an object for which the UE will perform measurement. The measurement object includes at least any one of an intra-frequency measurement object which is an object of intra-cell measurement, an inter-frequency measurement object which is an object of inter-cell measurement, and an inter-RAT measurement object which is an object of inter-RAT measurement. For example, the intra-frequency measurement object may indicate a neighbor cell having the same frequency band as the serving cell. The inter-frequency measurement object may indicate a neighbor cell having a frequency band different from the serving cell. The inter-RAT measurement object may indicate a neighbor cell of an RAT different from an RAT of the serving cell.

Meanwhile, the UE 100 also receives a radio resource configuration IE as illustrated.

The radio resource configuration dedicated IE is used to configure/modify/release a radio bearer, or to modify a MAC configuration. The radio resource configuration IE includes subframe pattern information. The subframe pattern information is information on a measurement resource restriction pattern on a time domain for measurement of RSRP and RSRQ for a primary cell (PCell).

[symbol]

### Next-Generation Mobile Communication Network

With the successful commercialization of mobile communication based on the 4G LTE/IMT (international mobile telecommunications) standard, research on the next-generation mobile communication (5G mobile communication) is underway. A 5G mobile communication system aims at higher capacity than the current 4G LTE, and can increase density of mobile broadband users and support device to device (D2D), high reliability, and machine type communication (MTC). The 5G research and development also aim at lower latency and lower battery consumption than a 4G mobile communication system to implement better Internet of things. A new radio access technology (new RAT or NR) may be proposed for the 5G mobile communication.

In the NR, it can be considered that a downlink (DL) subframe is used in reception from a base station and an uplink (UL) subframe is used in transmission to the base station. This approach may be applied to paired spectra and unpaired spectra. One pair of spectra implies that two carrier spectra are included for DL and UL operations. For example, in one pair of spectra, one carrier may include a DL band and a UL band which are paired with each other.

[symbol]

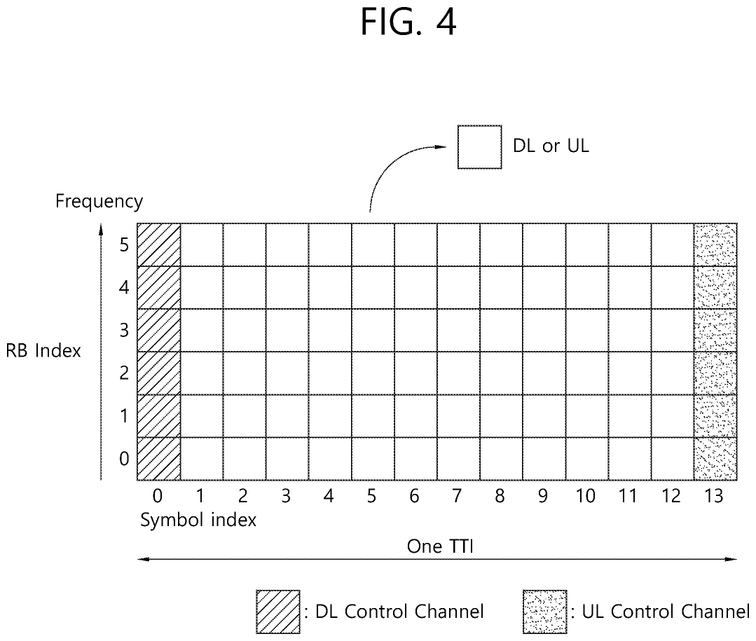

FIG. 4 shows an example of a subframe type in NR.

A transmission time interval (TTI) of FIG. 4 may be referred to as a subframe or slot for NR (or new RAT). A subframe (or slot) of FIG. 4 may be used in a TDD system of NR (or new RAT) to minimize data transmission latency. As shown in FIG. 4, the subframe (or slot) includes 14 symbols, similarly to the current subframe. A front portion symbol of the subframe (or slot) may be used for a DL control channel, and an end portion symbol of the subframe (or slot) may be used for a UL control channel The remaining symbols may be used for DL data transmission or UL data transmission. According to such a subframe (or slot) structure, DL transmission and UL transmission may be sequentially performed in one subframe (or slot). Accordingly, DL data may be received within the subframe (or slot), and a UL acknowledgement (ACK/NACK) may be transmitted within the subframe (or slot). The subframe (or slot) structure may be referred to as a self-contained subframe (or slot). The use of the subframe (or slot) structure has an advantage in that a time required to transmit data which has been erroneously received is reduced, thereby minimizing a final data transmission latency. In the self-contained subframe (or slot) structure, a time gap may be required in a process of transitioning from a transmission mode to a reception mode or from the reception mode to the transmission mode. For this, some OFDM symbols may be set to a guard period (GP) when switching from DL to UL in the subframe structure.

[symbol]

### Disclosures of the Present Specification

In the existing LTE-A system, a serving base station configures a measurement gap to a terminal, so that the terminal can measure a neighbor cell operating with an inter-frequency/inter-radio access technology (RAT). Therefore, the terminal performs cell detection and RSRP measurement after perform RF retuning within a duration of the measurement gap configured by the serving base station. Meanwhile, for cells on intra-frequency, the measurement gap is not configured since the terminal can perform measurement without the RF retuning.

However, in the 5G NR system, even if the terminal can perform measurement without RF retuning for cells on intra-frequency, beam sweeping for a beamforming direction is necessary since beamforming is applied in signal transmission.

Accordingly, a disclosure of the present specification aims to propose a scheme in which a 5G NR terminal configures a measurement gap for cell detection and RSRP measurement for cells on intra-frequency.

Similarly, in order for the 5G NR terminal to perform measurement on a neighbor cell operating with an inter-frequency/inter-radio access technology (RAT), a scheme is proposed in which a serving base station configures a measurement gap to the terminal.

[symbol]

In 5G NR, intra-frequency and inter-frequency are defined as follows.

(1) In terms of RRM measurement based on block (SSB) on which synchronization signal (SS) is transmitted

1) Intra-frequency in terms of SSB-based RRM measurement
When a center frequency of an SSB of a serving cell is the same as a center frequency of an SSB of a neighbor cell, this may be called an intra-frequency relation.
When the SSB of the serving cell and the SSB of the neighbor cell have the same subcarrier spacing, this may be called an intra-frequency region.

2) Inter-frequency in terms of SSB-based RRM measurement
When a center frequency of SSB of a serving cell is different from a center frequency of an SSB of a neighbor cell, this may be called an inter-frequency relation.
When the SSB of the serving cell and the SSB of the neighbor cell have a different subcarrier spacing, this may be called an inter-frequency region.

[symbol]

(2) In terms of RRM measurement based on CSI-RS

1) Intra-frequency in terms of RRM measurement based on CSI-RS
When a bandwidth of a CSI-RS resource configured for measurement on a neighbor cell exists within a bandwidth of a CSI-RS resource configured for measurement on a serving cell, this may be called an intra-frequency relation.
When the CSI-RS of the serving cell and the CSI-RS of the neighbor cell have the same subcarrier spacing, this may be called an intra-frequency relation.

2) Inter-frequency in terms of RRM measurement based on CSI-RS
When a bandwidth of a CSI-RS resource configured for measurement on a neighbor cell does not exist within a bandwidth of a CSI-RS resource configured for measurement on a serving cell, this may be called an inter-frequency relation.
When the CSI-RS of the serving cell and the CSI-RS of the neighbor cell have a different subcarrier spacing, this may be called an inter-frequency relation.

[symbol]

A measurement category is classified into three types as follows.
Intra-frequency measurement not requiring RF retuning
Intra-frequency measurement requiring RF retuning
inter-frequency measurement requiring RF retuning

[symbol]

### I. Cell Detection and Measurement for Cell on Intra-Frequency

In 5G NR, a synchronization signal (SS) (including PSS and SSS) and a physical broadcast channel (PBCH) including information (i.e., MIB) required when a terminal performs initial access are defined as an SS block. In addition, an SS burst may be defined by aggregating a plurality of SS blocks, and an SS burst set may be defined by aggregating a plurality of SS bursts. It is assumed that each SS block is beam-formed in a specific direction. Several SS blocks in the SS burst set are designed to support terminals existing in respective different directions.

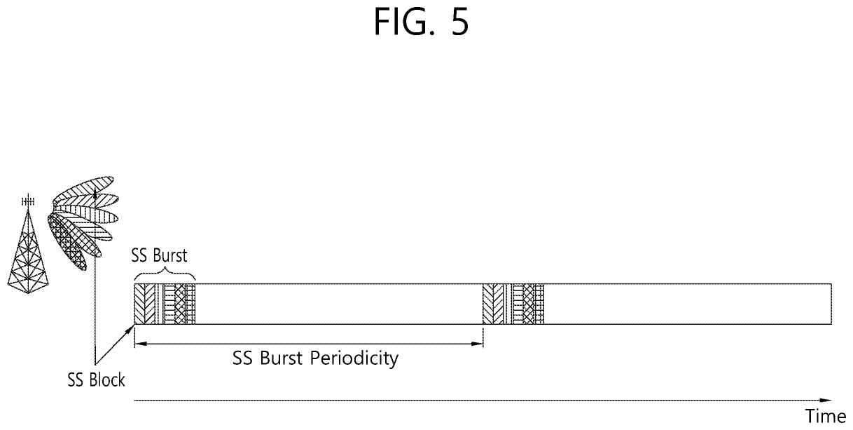

Meanwhile, beam sweeping is performed for an SS in 5G NR. This will be described with reference to FIG. 5.

[symbol]

FIG. 5 shows an example of beam sweeping of a synchronization signal (SS) in NR.

Referring to FIG. 5, an SS burst is transmitted every predetermined periodicity. In this case, a base station transmits each SS block in the SS burst while performing beam sweeping over time. Therefore, a terminal receives an SS block while performing beam sweeping, and performs cell detection and measurement.

[symbol]

A bandwidth and periodicity of the SS are configured from among the following candidate values.

(a) NR SS bandwidth
For frequency range category #1 (below 6 GHz) where candidate subcarrier spacing values are one of [15 kHz, 30 kHz, 60 kHz],
candidate minimum NR carrier bandwidths are [5 MHz, 10 MHz, 20 MHz], and
candidate transmission bandwidths of each synchronization signal are [1.08 MHz, 2.16 MHz, 4.32 MHz, 8.64 MHz]
For frequency range category #2 (above 6 GHz) where [120 kHz, 240 kHz] are candidate subcarrier spacing values,
candidate minimum NR carrier bandwidth are [20 MHz, 40 MHz, 80 MHz], and
candidate transmission bandwidth of each synchronization signal are [8.64 MHz, 17.28 MHz, 34.56 MHz, 69.12 MHz].

[symbol]

(b) Periodicity of SS
For carrier frequency range #1 (below 6 GHz), the periodicity of the SS is [5 ms, 10 ms, 20 ms, 40 ms, 80 ms, 100 ms].
For carrier frequency range #2 (above 6 GHz), the periodicity of the SS is [5 ms, 10 ms, 20 ms, 40 ms, 80 ms, 100 ms].

[symbol]

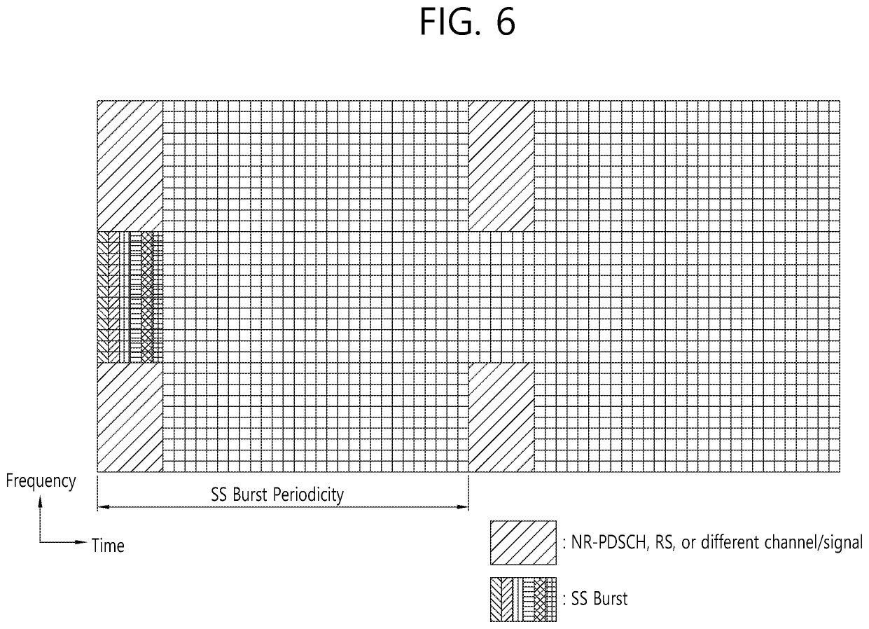

FIG. 6 shows a frequency position and periodicity of an SS burst.

When an SS is allocated based on combination of NR-based SS bandwidths, as shown in FIG. 6, instead of transmitting the SS at all frequency bands, the SS is allocated only to a specific frequency resource, and the SS is not allocated to the remaining other frequency resources. An NR-PDSCH or a reference signal (NR), or different information may be allocated in the remaining other frequency resources.

As described above, when a terminal performs measurement after detecting a corresponding cell by receiving an NR-based SS from a neighbor cell on an intra-frequency cell, although RF retuning is not necessary, the terminal shall perform an operation of beam sweeping unlike in the existing LTE/LTE-A system. Therefore, when the terminal is subjected to beam sweeping of a serving cell, the terminal cannot receive the SS from the neighbor cell. Likewise, when the terminal is subjected to beam sweeping of the neighbor cell, the terminal cannot receive a reference signal (RS) or an NR-PDSCH signal from the serving base station.

In order to solve this problem, a base station shall configure an additional time (e.g., an intra beam measurement gap) to the terminal. Therefore, the present specification proposes the following scheme.

In case of considering intra-frequency, since an SS signal transmitted from a neighbor cell may have the same subcarrier spacing as the SS from the serving cell, SS burst periodicities may be equal to or different from each other while a time duration for transmitting the SS is identical.

Accordingly, the present specification proposes to configure an intra beam measurement gap as follows according to the SS burst periodicity.

### I-1. When SS Burst Periodicity is Unified

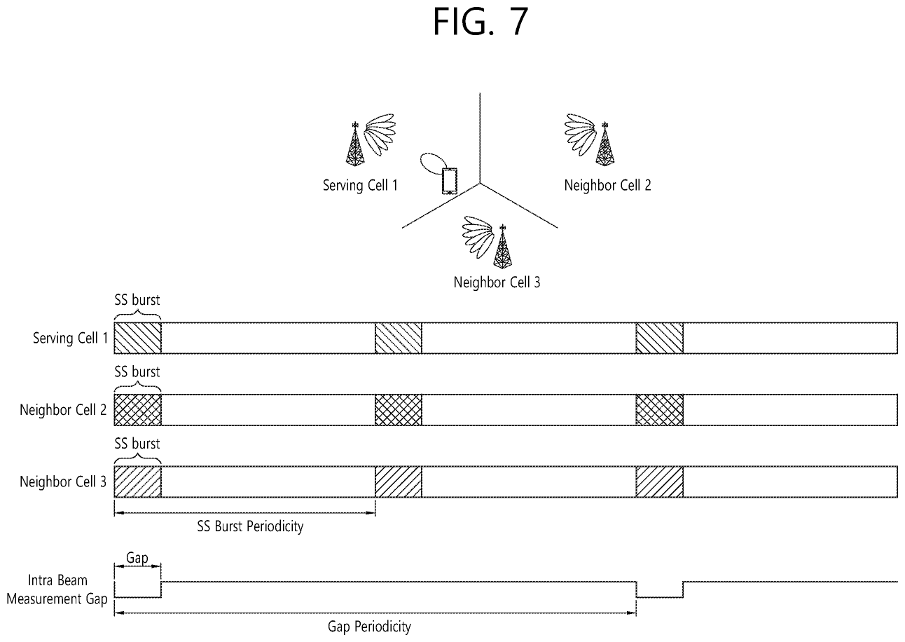

When neighbor cells operating on intra-frequency use one common SS burst periodicity, a time duration in which an SS of a serving cell is received and a time duration in which an SS of a neighbor cell is received may be set as shown in FIG. 7.

FIG. 7 shows an example in which a serving cell and neighbor cells have a unified SS burst periodicity.

As shown in FIG. 7, when a serving cell and neighbor cells have the same SS burst periodicity, the intra beam measurement gap periodicity may be set as follows.

Intra beam measurement gap periodicity=2*SS burst periodicity [Equation 1]

Meanwhile, a time duration of an intra beam measurement gap may be set to be equal to a time duration of an SS burst as follows.

Time duration of intra beam measurement gap=time duration of SS burst [Equation 2]

[symbol]

### I-2. When SS Burst Periodicity is Different

### I-2-1. When SS Burst Periodicity is Totally Different Between Serving Cell and Neighbor Cells

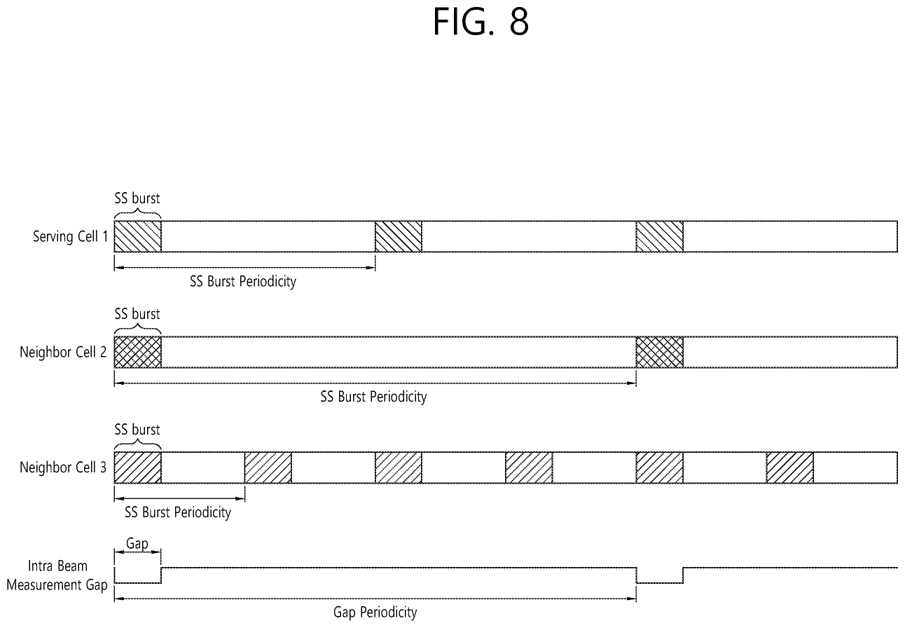

When neighbor cells operating on intra-frequency use different SS burst periodicities which are not matched to an SS burst periodicity of a serving cell, a duration in which an SS of a serving cell is received and a time at which an SS of a neighbor cell can be received may be set as shown in FIG. 8.

FIG. 8 shows an example in which SS burst periodicities of a serving cell and neighbor cells are set differently.

As shown in FIG. 8, when SS burst periodicities of a serving cell and neighbor cells are different, an intra beam measurement gap periodicity may be set as follows.

Intra beam measurement gap periodicity=2*SS burst periodicity of serving cell [Equation 3]

Meanwhile, a time duration of an intra beam measurement gap may be set to be equal to a time duration of an SS burst as shown in Equation 2.

[symbol]

### I-2-2. When There is Certain Common Feature Between SS Burst Periodicity of Serving Cell and SS Burst Periodicity of Neighbor Cell

When a certain common feature is shared between an SS burst periodicity of a serving cell and an SS burst periodicity of a neighbor cell, with respect to a cell to be monitored by a terminal, the serving cell may configure an intra beam measurement gap of the terminal according to a relation between the SS burst periodicity of the serving cell and the SS burst periodicity of the neighbor cell. When there is a change in the cell to be monitored according to a mobility of the terminal, the serving cell may change a configuration of the intra beam measurement gap of the terminal.

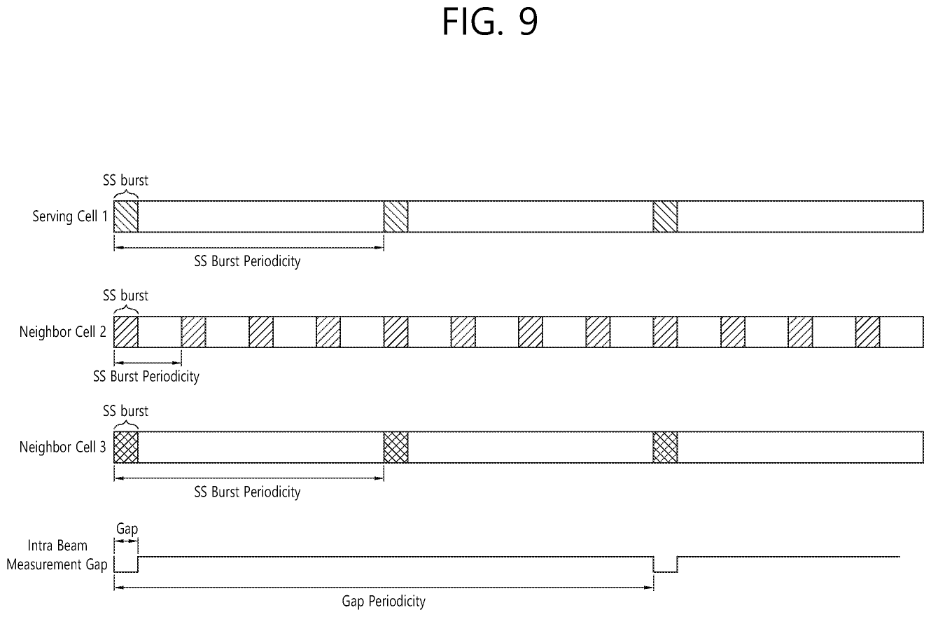

FIG. 9 shows a case where there is an SS burst periodicity of a serving cell out of SS burst periodicities of neighbor cells.

As shown in FIG. 9, an SS burst periodicity of a serving cell may be four times an SS burst periodicity of a neighbor cell 2, and an SS burst periodicity of a neighbor cell 3 may be equal to the SS burst periodicity of the serving cell. As such, when there is the same SS burst periodicity of the serving cell out of the SS burst periodicities of the neighbor cells, the intra beam measurement gap periodicity may be set as follows.

Intra beam measurement gap periodicity=offset+2*SS burst periodicity of serving cell [Equation 4]

In this case, a time duration of an intra beam measurement gap may be set to be equal to a time duration of an SS burst as shown in Equation 2.

[symbol]

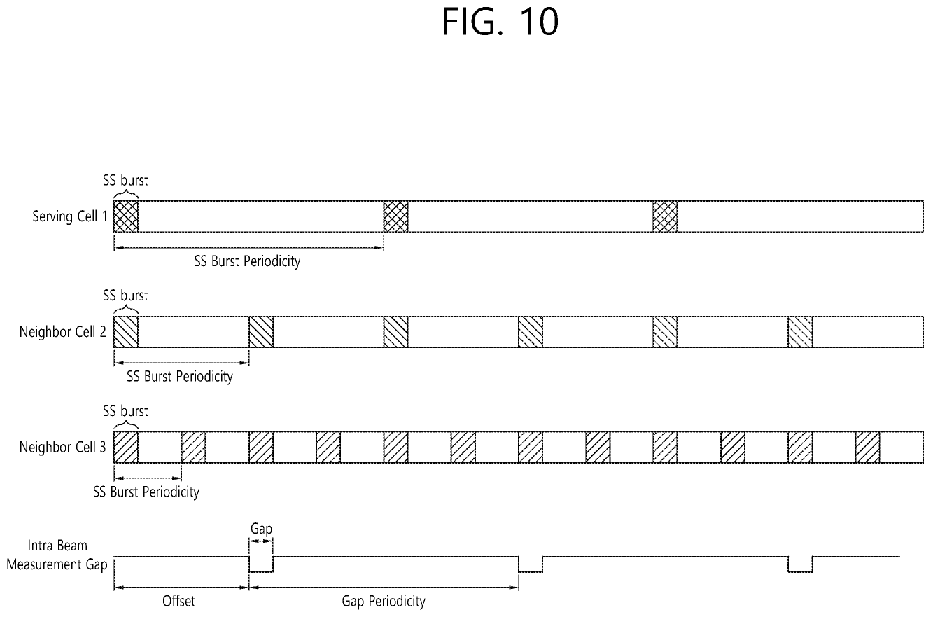

FIG. 10 shows a case where a least common multiple (LCM) of SS burst periodicities of neighbor cells is less than an SS burst periodicity of a serving cell.

As shown in FIG. 10, an SS burst periodicity of a serving cell is two times an SS burst periodicity of a neighbor cell 2, and the SS burst periodicity of the neighbor cell 2 is two times an SS burst periodicity of a neighbor cell 3. In other words, the SS burst periodicity of the neighbor cell 3 is ½ of the SS burst periodicity of the neighbor cell 2, and the SS burst periodicity of the neighbor cell 2 is ½ of the SS burst periodicity of the serving cell. In this example, a least common multiple (LCM) between the SS burst periodicities may correspond to the SS burst periodicity of the serving cell. In this case, the intra beam measurement gap periodicity may be set as follows.

Intra beam measurement gap periodicity=offset+SS burst periodicity of serving cell [Equation 5]

In this case, a time duration of an intra beam measurement gap may be set to be equal to a time duration of an SS burst as shown in Equation 2.

The offset may be a least common multiple (LCM) for the SS burst periodicities of the neighbor cells except for the serving cell.

[symbol]

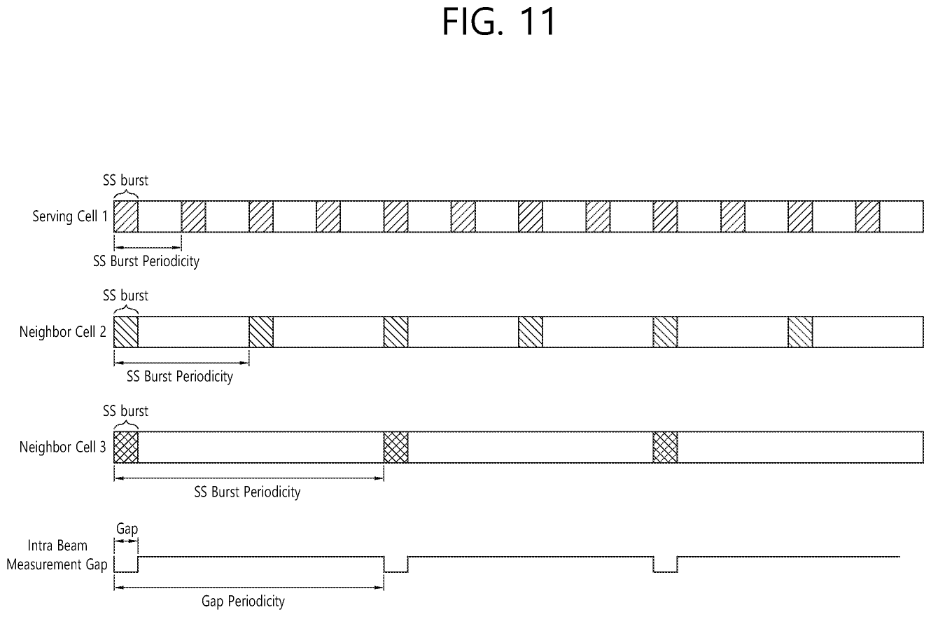

FIG. 11 shows a case where a least common multiple (LCM) of SS burst periodicities of neighbor cells is greater than an SS burst periodicity of a serving cell.

As shown in FIG. 11, an SS burst periodicity of a serving cell is ½ of an SS burst periodicity of a neighbor cell 2, and the SS burst periodicity of the neighbor cell 2 is ½ of an SS burst periodicity of a neighbor cell 3. In other words, the SS burst periodicity of the neighbor cell 3 is two times the SS burst periodicity of the neighbor cell 2, and the SS burst periodicity of the neighbor cell 2 is two times the SS burst periodicity of the serving cell. In this case, the intra beam measurement gap periodicity may be set as follows.

Intra beam measurement gap=offset+least common multiple (LCM) [Equation 6]

In the equation above, the least common multiple (LCM) implies a least common multiple for the SS burst periodicities of the neighbor cells.

In this case, a time duration of the intra beam measurement gap may be set to be equal to a time duration of the SS burst as shown in Equation 2.

In Equations 5 and 6, the offset may be set to 0. A reference point of the offset may be defined by considering an SS burst of the serving cell.

[symbol]

II. RSRP measurement for cell operating on intra-frequency

A terminal performs beam sweeping towards a serving cell in an RRC connected mode. Therefore, in order to measure RSRP for another neighbor cell, an accurate measurement value can be obtained only when the RSRP is measured after performing beam sweeping in a beam direction of a corresponding cell.

Meanwhile, an NR system may use an SS block (including a synchronization signal (SS) signal, a PBCH, and a DM-RS signal of the PBCH) or may use a reference signal (RS) (e.g., mobility RS) in order to measure RSRP for determining whether to move (i.e., determining of a handover).

(1) RSRP measurement using SS block

When a terminal measures RSRP of a neighbor cell by using an SS block, the intra beam measurement gap configuration proposed in the above section may be used.

(B) RSRP measurement using additional reference signal (RS) (e.g., mobility RS)

When a terminal measures RSRP by using an additional RS other than an SS block, an additional gap (hereinafter, an intra RSRP measurement gap) is required for beam sweeping of the terminal in a direction of a neighbor cell in addition to an intra beam measurement gap.

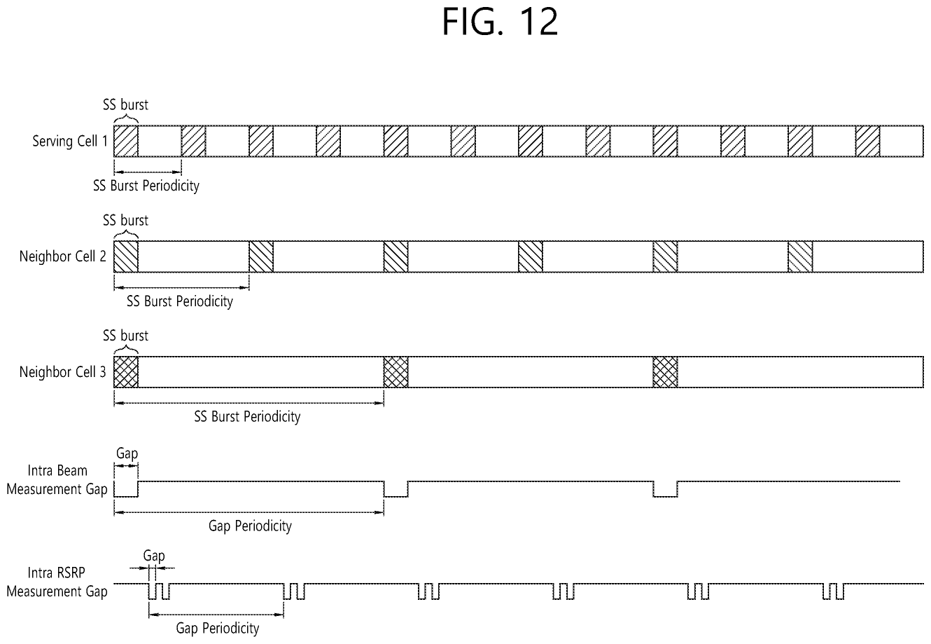

FIG. 12 shows an example of an intra RSRP measurement gap to be proposed.

An example shown in FIG. 12 shows a case where a least common multiple (LCM) of SS burst periodicities of neighbor cells is greater than an SS burst periodicity of a serving cell as shown in FIG. 11. In this case, an intra beam measurement gap periodicity may be set as described above in Equation 6.

In this case, a specific number of intra RSRP measurement gaps may be located between intra beam measurement gap periodicities. In this case, the intra RSRP measurement gap is configured not to overlap with an SS burst of a serving cell, and N intra RARP measurement gaps are configured by considering an RS transmission periodicity for RSRP measurement in a duration of [SS burst periodicity−SS burst] with respect to the serving cell.

The intra RSRP measurement gap periodicity may be set variably as shown in the following equation according to the number of neighbor cells of which RSRP is to be measured, the number of beams based thereon, and a mobility facture of a terminal.

Intra RSRP measurement gap periodicity=Y*SS burst periodicity of serving cell [Equation 7]

Herein, Y=1, 2, 3, . . .

For example, the value Y may be set to be small when the number of beams and neighbor cells for measuring RSRP is great. On the other hand, when the number of beams and neighbor cells for measuring RSRP is small, the value Y may be set to be great so that a time for receiving data from a serving cell is more secured. In addition, by considering a mobility feature of the terminal, the value Y may be set to be great when in a slow speed state or a stationary state, and the value Y may be set to be small when in a high speed state.

[symbol]

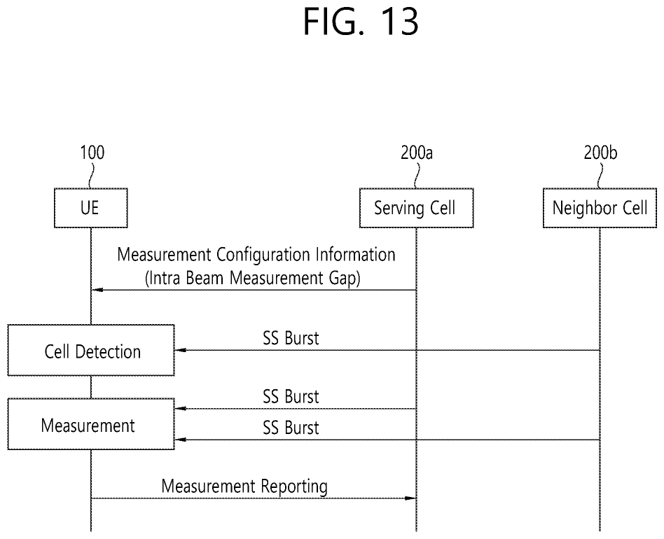

FIG. 13 is a flowchart briefly summarizing and showing a disclosure of the present specification.

As can be seen with reference to FIG. 13, a terminal may receive measurement configuration information from a serving cell. The measurement configuration information may include information on a first measurement gap, e.g., an intra beam measurement gap. In addition, the measurement configuration information may include information on a second measurement gap, e.g., an intra RSRP measurement gap.

The terminal may receive an SS burst from one or more neighbor cells to perform cell detection.

In addition, the terminal may perform measurement based on the SS burst received from the one or more neighbor cells during a first measurement gap (e.g., an intra beam measurement gap) indicated by the information.

In addition, although not shown, the terminal may perform RSRP measurement based on a reference signal (RS) from the one or more neighbor cells during the second measurement gap.

In addition, the terminal may perform measurement reporting.

The aforementioned embodiments of the present invention can be implemented through various means. For example, the embodiments of the present invention can be implemented in hardware, firmware, software, combination of them, etc. Details thereof will be described with reference to the drawing.

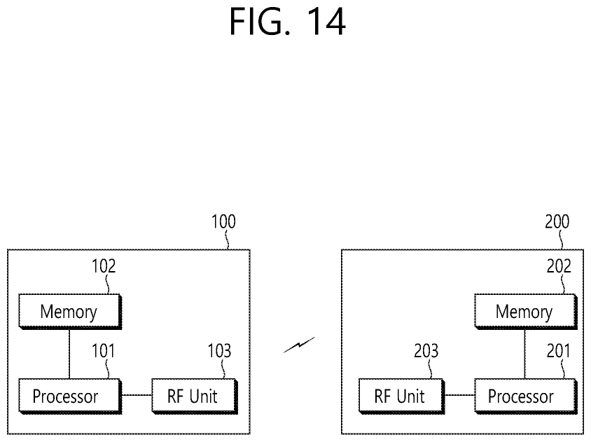

FIG. 14 is a block diagram showing a wireless communication system for implementing a disclosure of the present specification.

A BS 200 includes a processor 201, a memory 202, and a radio frequency (RF) unit 203. The memory 202 is coupled to the processor 201, and stores a variety of information for driving the processor 201. The RF unit 203 is coupled to the processor 201, and transmits and/or receives a radio signal. The processor 201 implements the proposed functions, procedures, and/or methods. In the aforementioned embodiment, an operation of the BS may be implemented by the processor 201.

A UE 100 includes a processor 101, a memory 102, and an RF unit 103. The memory 102 is coupled to the processor 101, and stores a variety of information for driving the processor 101. The RF unit 103 is coupled to the processor 101, and transmits and/or receives a radio signal. The processor 101 implements the proposed functions, procedures, and/or methods.

The processor may include Application-specific Integrated Circuits (ASICs), other chipsets, logic circuits, and/or data processors. The memory may include Read-Only Memory (ROM), Random Access Memory (RAM), flash memory, memory cards, storage media and/or other storage devices. The RF unit may include a baseband circuit for processing a radio signal. When the above-described embodiment is implemented in software, the above-described scheme may be implemented using a module (process or function) which performs the above function. The module may be stored in the memory and executed by the processor. The memory may be disposed to the processor internally or externally and connected to the processor using a variety of well-known means.

In the above exemplary systems, although the methods have been described based on the flowcharts using a series of the steps or blocks, the present invention is not limited to the sequence of the steps, and some of the steps may be performed at different sequences from the remaining steps or may be performed simultaneously with the remaining steps. Furthermore, those skilled in the art will understand that the steps shown in the flowcharts are not exclusive and may include other steps or one or more steps of the flowcharts may be deleted without affecting the scope of the present invention.

What is claimed is:

1. A measurement method comprising:
receiving information on a first measurement gap from a serving cell; and
performing measurement based on a synchronization signal (SS) burst received from one or more neighbor cells during the first measurement gap indicated by the information,
wherein the SS burst includes a plurality of SS blocks,
wherein the first measurement gap is configured based on a periodicity of the SS burst for the serving cell and a periodicity of the SS burst for the one or more neighbor cells, and
wherein reception of the signal from the serving cell is stopped during the first measurement gap.

2. The measurement method of claim 1, wherein during the first measurement gap, beam sweeping is performed to receive the SS burst from the neighbor cell.

3. The measurement method of claim 1, wherein the serving cell and the neighbor cell have an intra-frequency relation.

4. The measurement method of claim 1, wherein the SS block includes one or more of a primary synchronization signal, a secondary synchronization signal, and a physical broadcast channel (PBCH).

5. The measurement method of claim 1, further comprising:
receiving information on a second measurement gap from the serving cell; and
performing reference signal received power (RSRP) measurement based on a reference signal (RS) from the one or more neighbor cells during the second measurement gap.

6. The measurement method of claim 5, wherein the first measurement gap and the second measurement gap do not overlap with each other.

7. The measurement method of claim 1, wherein if a periodicity of an SS burst for the serving cell and a periodicity of an SS burst for the one or more neighbor cells are fully matched to each other, the first measurement gap is configured based on the periodicity of the SS burst for the serving cell.

8. The measurement method of claim 1, wherein if there is any neighbor cell of which a periodicity of an SS burst is matched to a periodicity of an SS burst for the serving cell, the first measurement gap is configured based on a multiple for the periodicity of the SS burst for the serving cell.

9. The measurement method of claim 1, wherein if a least common multiple (LCM) of SS burst periodicities of the neighbor cells is less than the SS burst periodicity of the serving cell, the first measurement gap is configured based on the periodicity of the SS burst for the serving cell.

10. The measurement method of claim 9, wherein the first measurement gap is configured by further considering an offset.

11. A terminal comprising:
a transceiver for receiving information on a first measurement gap from a serving cell; and
a processor for performing measurement based on a synchronization signal (SS) burst received from one or more neighbor cells during the first measurement gap indicated by the information,
wherein the SS burst includes a plurality of SS blocks,
wherein the first measurement gap is configured based on a periodicity of the SS burst for the serving cell and a periodicity of the SS burst for the one or more neighbor cells, and
wherein reception of the signal from the serving cell is stopped during the first measurement gap.

12. The terminal of claim 11,
wherein the transceiver further receives information on a second measurement gap from the serving cell, and
wherein the processor further performs reference signal received power (RSRP) measurement based on a reference signal (RS) from the one or more neighbor cells during the second measurement gap.

13. The terminal of claim 12, wherein the first measurement gap and the second measurement gap do not overlap with each other.
